(19) United States
(12) Patent Application Publication
(10) Pub. No.: US 2008/0029656 A1
(43) Pub. Date: Feb. 7, 2008

(54) Guide for cords, cables and wires

(76) Inventor: John Feehan, Long Beach, CA (US)

Correspondence Address: Law Office of Terry L. Miller, 24832 Via San Fernando, Mission Viejo, CA, 92692, US

(21) Appl. No.: 11/489,753

(22) Filed: Jul. 20, 2006

(51) Int. Cl. F16L 3/08

(52) U.S. Cl. 248/65

(57) ABSTRACT

A guide device for cords, wires, and cables, possibly at or associated with a desk or table upon which is disposed a computer center in the home or office, includes an elongate guide member having a base portion which may be secured adjacent to an edge of the desk or table, and a protruding flange portion at least part of which is preferably yieldable. This flange portion defines plural spaced apart apertures or openings each for receiving one or more cords, cables, or wires. And, the flange portion also defines a slot or slit communicating each opening or aperture to a distal edge of the flange so that adjacent parts of the flange (or flange edges) may be flexed or yielded relative to one another in order to pass a cord, wire, or cable along the slit into or from a respective aperture. Once the cord, wire or cable is received into an aperture of the flange portion, the flange edges may resiliently return to alignment, retaining the cord, wire or cable in the respective aperture of the guide device.

### FIELD OF THE INVENTION

This invention relates generally to a guide for a cord, cable, or wire. More particularly, this invention relates to a cord, cable or wire guide which has particular utility for use at a desk in the home or office environment at which is located a computer system or computer system components (possibly including, for example, a computer processor, monitor, keyboard, mouse, dial-up or cable internet modem, telephone line, a printer, a scanner, a notebook dock, and possibly a plotter, each of which have a power cord and one or more data cords and which are all interconnected parts of a computer system via connecting cables, cords, and wires). Thus, the cord, cable and wire guide accepts and arranges plural cords, cables and wires so as to provide an organized arrangement of these cords, wires and cables. Further, in the event that one or more of the components of the computer system is temporarily disconnected, the guide retains the cords, cables and wires associated with that component in a convenient location for re-connection when the component is returned to the system. Because the cords and cables are retained in locations identifiable to the user, the guide device also serves to identify particular cords and cables. Thus, the present cord, cable and wire guide provides for an organized and logical routing of the various cords, cables and wires at a home or office computer center, as well as for retention of the cord, cable or wire position in the desired arrangement and routing in the event that one or more of the devices is temporarily disconnected.

### BACKGROUND OF THE INVENTION

The current art relating to wire harnesses or wire guides utilizes several arrangements for routing and protecting wires within an environment. For example, one arrangement of wire or cable guide uses a plastic braid to surround a bundle of wires or cables so as to provide abrasion protection for the wire or cable. A steel shroud routes the wires or cable within a particular environment. This device and method tends to be very labor intensive and requires a special braiding machine to encapsulate the wires.

Another wire or cable guide arrangement uses a duct with detachable fingers for retaining wire or cable within the duct and for facilitating the addition of wires to the bundle. A duct cover may then be placed over the entire duct to retain all the wires or cable. Still another arrangement uses an adjustable clip for retaining wires or cable within a duct. The clip is easily attachable and detachable to the duct walls as well as being adjustable on the duct walls.

The wire harness described in U.S. Pat. No. 5,374,778, entitled “Wire Harness,” to Hashimoto et al., is confined to using adhesive tape to bundle together shielded wires having opposite ends connected to connectors. The adhesive tape is not reusable if it is desired to remove the shielded wires from the connectors. New adhesive tape would be required to re-bundle the shielded wires.

The apparatus described in U.S. Pat. No. 6,051,789, entitled “Corrugated Tube and Wire Harness Having The Tube As A Cover,” to Kato, is not easily adaptable for use by the general consumer to harness wires from a computer or entertainment center. The bundled wires are housed by a corrugated tube which has two end regions circular in cross-section and a central region elliptical in cross-section. When installed, the central region of the wire harness is positioned on the floor such that the projection perpendicular to the floor by the central region of the tube is reduced and results in the harness requiring less space. The tube includes a resilient expansion slit which allows a wire bundle to be inserted in or removed from the tube. However, the tube must be specifically fabricated for its use because one size does not fit all applications.

The method described in U.S. Pat. No. 6,332,248 B1, entitled “Wire Harness Bounding Method,” to Daniggelis et al., is elaborate, time consuming and not easily adaptable for use by the general consumer in securing computer wires and the like. The method includes a bundle of wires and a cable tie wherein the cable tie has a strap body and a locking head with first and second strap passages that each have a pawl that locks in the same direction. The strap body is wrapped around at least one of the wires and inserted through the first strap passage. Next the strap body is wrapped around the bundle and inserted through the second strap passage. The strap body is then tightened and the residual strap portion clipped.

Notwithstanding the usefulness of the prior art, they do not provide a simple cost effective means for routing wires or cable in a home or office environment. What is needed is an inexpensive device that is simple to use and can be easily installed to guide the wires and the cables of a home or office computer system. Of course, such a wire and cable guide will also find application to other used in the office and home environments because of the many wires and cables of computer systems, entertainment centers and the like.

### SUMMARY OF THE INVENTION

In view of the deficiencies of the related art, it is an object for this invention to ameliorate or overcome one or more of these deficiencies.

It is an aspect of the present invention to provide a device that conveniently and logically guides and retains cables and wires in the context of a home or office computer installation.

To accomplish these and other aspects of the present invention an elongate guide device for cords, cables, and wires, is particularly adapted for installation at an edge of a desktop for guiding and retaining cords, cables and wires of a computer system disposed at a desk, the guide device comprising: an elongate base portion adapted for securing to an edge of a desktop; the base portion carrying a elongate protruding flange portion protruding away from the desktop; the flange portion defining plural apertures spaced along its length, and plural slits each connecting a respective one of the plural apertures with a distal edge of the flange portion and having adjacent edges defined by parts of the protruding flange portion; whereby, adjacent edges of the plural slits are yieldable out of alignment so as to allow a cord, cable, or wire to be angulated relative to the flange and to be moved in a first orientation along the slit into a respective one of the plural apertures, so that when the cord, cable or wire depends by its own weight in a second generally vertical orientation, the cable, cord or wire is captively retained in the aperture.

One of the primary users of this guide device may be by laptop users who don't have a docking station and just leave their cords and cables hanging around their desk after they pack-up the laptop computer for travel or remote use. In such a use the guide device by organizing and helping to identify the various cords and cables makes the job of interconnecting the laptop computer to the peripheral devices much easier.

These and other aspects of the present invention will become apparent from the following description, the description being used to illustrate the preferred embodiment of the invention when read in conjunction with the accompanying drawings.

### BRIEF DESCRIPTION OF THE DRAWING FIGURES

FIG. 1 provides a fragmentary perspective view of a computer center on a desk carrying a cord, wire, or cable guide embodying the present invention;

FIG. 1A is a fragmentary view of an encircled portion of FIG. 1, and is presented at a larger size for ease of viewing;

FIG. 2 provides a fragmentary view similar to FIG. 1A, but showing the cord, cable, or wire guide in an alternative configuration allowing a cord to be inserted into or removed from the guide;

FIG. 3 is a fragmentary view similar to FIGS. 1A and 2, but showing a cord captured in a guide according to this invention, and a connector of the cord being retained in an accessible location by the guide;

FIGS. 4 and 5 illustrate an alternative embodiment of the invention.

### DETAILED DESCRIPTION OF PREFERRED EMBODIMENTS OF THE INVENTION

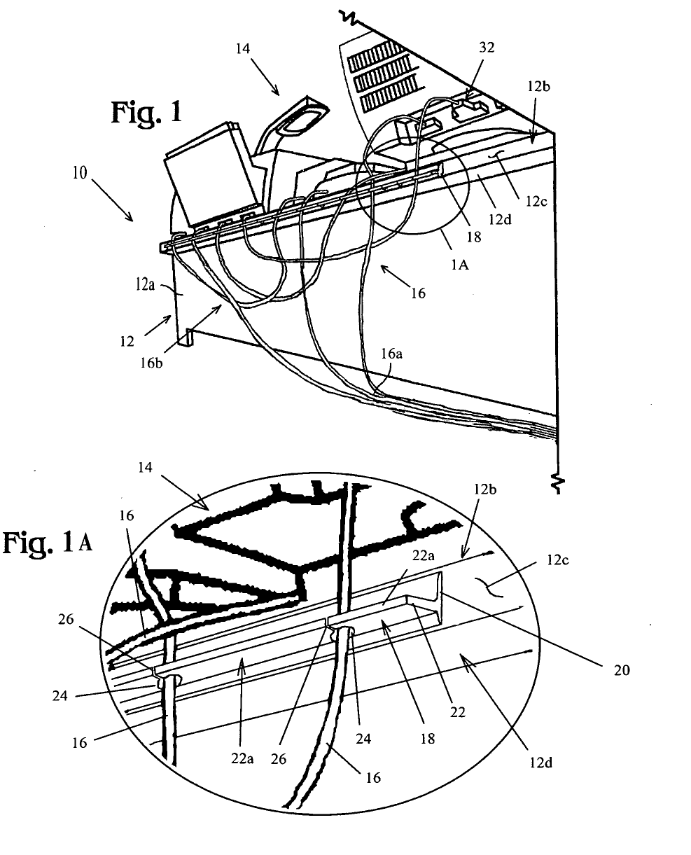

FIG. 1 provides a perspective view of a computer center 10, which may for example, be a home or office computer center. This computer center 10 includes a desk or table 12, having a base 12a with a top 12b (defining a top surface also referenced with the numeral 12b). As is seen in FIG. 1, the top 12b slightly overhangs or protrudes outwardly of the base 12a, and defines a side edge surface 12c. The protruding portion of the top 12b at its underside also defines a downwardly disposed underside marginal portion 12d.

As is seen in FIG. 1, on the top 12b are disposed several computer components, or ancillary devices or components, all generally referenced with the numeral 14. Many of these components 14 have power or signal cords, wires or cables, generally indicated with the numeral 16, many of which hang off the desk top 12b over side edge surface 12c. As used herein, the words: wire, cable, and cord, are used somewhat interchangeably and indicated the electrical power and signal interconnections of the computer system 10 generally.

A group of power cords 16a extends to a location where line power is provided (i.e., to a power strip or uninterruptable power supply, for example—not seen in the drawing Figures). Others of the cords, wires, or cables (indicated generally with the numeral 16b) interconnect various components of the computer system 14, and may be considered as data cables (or wires or cords). In order to provide for a desired logical and organized arrangement of these cords, cables, and wires 16, an elongate guide device 18 (best seen in FIGS. 1 and 1A) is attached at the desk top side edge surface 12c. In order to attach the guide device 18, screws or double-sided tape, for example, may be employed, as will be further explained.

This guide device 18 is generally T-shaped in cross sectional end view, and includes an elongate base portion 20 (i.e., the cross bar of the T-shape) securing to the side edge surface 12c, and an elongate flange portion 22 projecting outwardly generally parallel to the top surface 12b. In this preferred embodiment, the base portion 20 is secured to the side edge surface 12c of desk 12 by means of interposed double-sided tape, not seen in the drawing Figures. However, it will be apparent that the cross bar portion or base portion 20 is sufficiently large that holes through this portion may be provided allowing plural screws (also not seen in the drawing Figures) to penetrate the portion 20 so as to engage into the desk top 12b at side edge surface 12b.

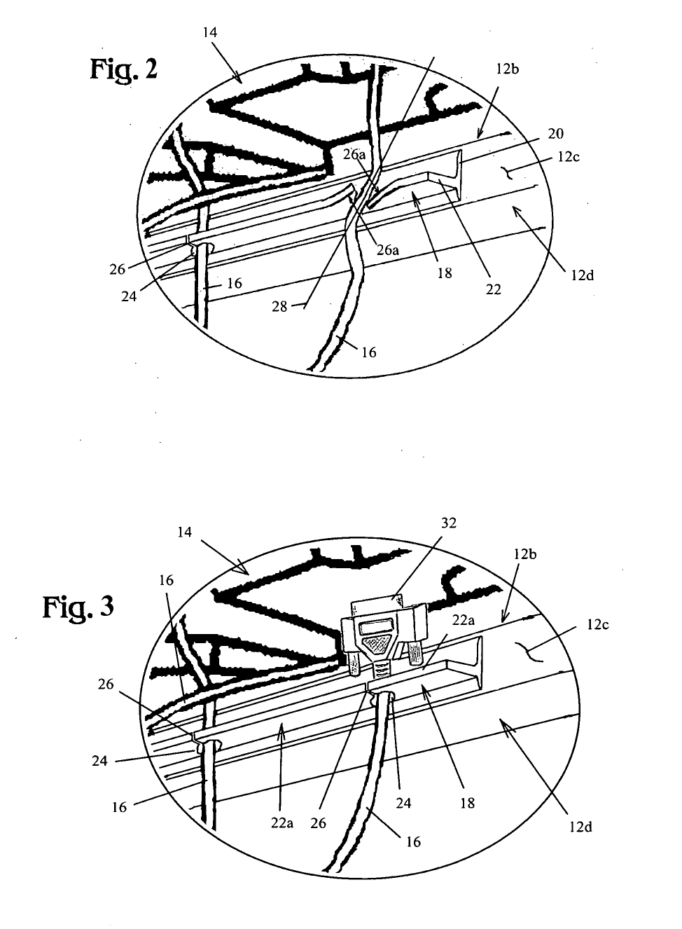

The flange portion 22 defines a termination edge 22a disposed away from the base portion 20 and from the side edge surface 12c. Further, spaced along the length of the elongate guide device 18, the flange portion 22 defines plural openings or apertures 24 each for receiving one or more of the plural cords, cables, or wires 16. These plural apertures 24 may be of a single size, or may be varied in size in order to better receive and retain cords, cables, or wires of various sizes, as will be well understood by those ordinarily skilled in the pertinent arts. In order to facilitate entry (and exit) of a cord, cable, or wire into (and from) an aperture 24, the flange portion 22 defines plural slits 26, each extending from a respective one of the plural apertures 24 to the termination edge 22a. These slits 26 are too narrow to allow a cord to enter or exit the connected aperture 24. However, at least between the apertures 24 and the termination edge 22a, the flange portion 22 is yieldable so that a user of the guide device 18 may deflect adjacent parts of the flange portion 22 (i.e., by the application of manual force between or adjacent to slits 26—as is best seen in FIG. 2 as indicated by the force arrows 26a). That is, the adjacent edges of a slit 26 are moved away from a planar alignment (as was seen in FIGS. 1 and 1A) and to a relatively vertically spaced arrangement of the adjacent sides of a slit 26 by application of manual force 26a applied with a users fingers, for example. This movement of the adjacent edges of a slit 26 to a second spaced apart position allows a cord, cable, or wire to be positioned angularly relative to the elongate extent of guide 18 (i.e., along an angulated line 28, viewing FIG. 2) and to be thus passed between the adjacent sides of a slit 26, into or out of a respective one of the apertures 24.

Most preferably, the flange portion 22 between the apertures 24 and the termination edge 22a is not only yieldable, but is also resilient to a desired degree, so that after this portion is yieldably distorted from its undistorted position of planar alignment (as seen in FIGS. 1 and 1A) to its yielded or distorted second position (as seen in FIG. 2) in order for a cord, cable or wire to be inserted into or removed from a respective aperture 24. Then, when the user discontinues the application of manual force 26a, the distorted portion of the flange 22 will return essentially to its undistorted position as seen in FIGS. 1 and 1A. For this purpose, it is desirable for the guide 18 to be formed of extruded or injection molded polymer (i.e., plastic) having a desired Durometer and flexibility allowing it to be manually distorted at adjacent sides of a slit 26 to the second position of FIG. 2, and also having sufficient resilience and shape-retaining nature that the material will return essentially to its aligned position of FIGS. 1 and 1A.

However, this resilience of the flange portion is a desired feature of the preferred embodiment, and is not an essential feature of the invention. That is, as is seen in FIG. 2, if the flange portion 22 remains yielded out of planar alignment, and in a position with adjacent parts of the flange portion 22 (i.e., adjacent edges of a slit 26) each angulated generally as seen in FIG. 2, then cords, cables and wires may be placed into the respective apertures 24 by extending the cord, cable or wire generally along the angulated line 28 where the cord traverses the guide 18 so that the cord, cable or wire may pass between the adjacent edges of the slit 26 and portions of the flange 22 into and from a respective aperture 24. However, once received in the respective aperture 24, when the cord, cable or wire is allowed to depend by its own weight generally vertically (as seen in FIGS. 1 and 1A) it takes up an alignment generally perpendicular to the flange 24 (i.e., generally perpendicular to the length of guide 18 and angulated line 28—although not fully to a 90 degree angle relative to angulated line 28) and is thus movably captured in the respective aperture 24.

Further, and desirably, the captured cord, cable or wire 16 in an aperture 24 is sufficiently smaller than the aperture 24 that it may freely move length wise through the respective aperture 24. Thus, further to the above, it will be apparent that should it be desired for a user of the guide device 18 to disconnect any one or more of the captured cords, cables, or wires from any of the components 14 (perhaps for service of the component or for use at another location), then the connector (for example, generally referenced with the numeral 32) at the termination end of this cord, cable or wire may rest upon the upper surface of flange 22 (best seem in FIG. 3) in a very convenient and accessible location while the particular cord, cable or wire remains in the same position and arrangement it had before being disconnected from the particular component. Moreover, after the user of the guide device has finished servicing or using the particular component and returns that component to its position in the computer system 14, each of the cords, cables, and/or wires associated with and to be connected to that component are readily available and accessible at the upper side of guide device 18. That is, the cords, cables or wires associated with the device will have been prevented by the device 18 from falling below or behind the desk 12, and will be readily available and accessible to the user for re-connection to the component of the computer system 14. As will be apparent to those ordinarily skilled in the pertinent arts, in the event that a particular cord, cable or wire includes a connector sufficiently small that it may slip through the aperture 26 rather than resting upon the upper surface of the flange 22 (as may be the case with a telephone wire or RGU coaxial cable, for example), the user of the device 18 may conveniently place a split annulus or split washer formed of plastic or rubber about the wire just above the flange 22. These washers (which may be supplied with the device 18) would have center holes sufficiently small that they grip upon the various wires, cables, and cords and an outer diameter too large to pass through the apertures 26, thus preventing the particular cords from falling through the respective apertures 26.

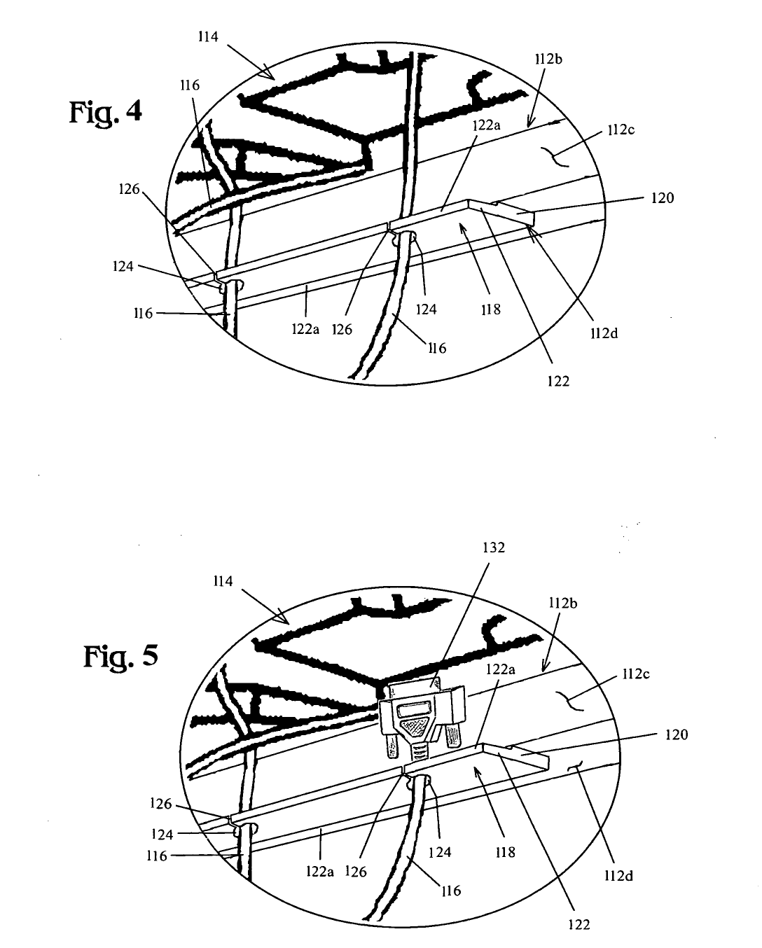

Turning now to FIGS. 4 and 5 an alternative embodiment of the present invention is depicted. This embodiment has several features in common with the first embodiment disclosed and described above. Accordingly, features of this second embodiment which are the same as or analogous in structure or function to those described above are referenced in Figures with the same numeral used above, and increased by one-hundred (100).

Viewing FIGS. 4 and 5 in conjunction with one another, it is seen that an elongate guide device 118 is attached at the desk top surface 112b or 112d. That is, the guide 118 is preferably attached either to the top or bottom surface horizontal of the desktop 112b, although some users may prefer to attach the guide device 118 to the vertical edge 112c. In order to attach the guide device 118 at the top or underside surface of the desk top 112b, use of double-sided tape is most preferred, although screws may also be employed with this embodiment, especially when the guide device 118 is attached to the underside surface 112d. The guide device 118 includes an elongate base portion 120 securing to the desk top 12b, and an elongate flange portion 122 projecting outwardly generally parallel to the top and bottom surfaces 112b and 112c. The flange portion 122 defines a termination edge 122a disposed away from the base portion 120 and from the side edge surface 112c. As can be appreciated by comparison of FIGS. 1 and 1A with FIGS. 4 and 5, while the first embodiment of the invention is generally T-shaped in cross section, the second embodiment is generally planar. That is, the flange portion 122 is generally planar with the base portion 120 from which extends the flange portion 122.

In this second embodiment also, spaced along the length of the elongate guide device 118, the flange portion 122 defines plural openings or apertures 124 each for receiving one or more of the plural cords, cables, or wires 116. From each respective one of the plural apertures 124 extends a respective one of plural slits 126 extending to the termination edge 122a. This embodiment is used in the same way as the first embodiment described above.

While there has been illustrated and described what is at present considered to be the preferred embodiments of the invention, it should be appreciated that numerous changes and modifications are likely to occur to those skilled in the art. It is intended in the appended claims to cover all those changes and modifications that fall within the spirit and the scope of the present invention.

1. An elongate guide device for cords, cables, and wires, said guide device being particularly adapted for installation along an edge of a desktop for guiding and retaining cords, cables and wires of computer system components disposed upon said desktop, said guide device comprising:
an elongate base portion adapted for securing to an edge of a desktop;
said base portion carrying a elongate yieldable flange portion protruding away from the desktop;
said yieldable flange portion defining plural apertures spaced along its length, and plural fine-dimension slits each connecting a respective one of said plural apertures with a distal edge of said yieldable flange portion and having adjacent closely spaced apart and aligned slit edges defining said fine-dimension slits defined by parts of said protruding yieldable flange portion;
whereby, adjacent slit edges of said yieldable flange portion are yieldable out of alignment so as to allow a cord, cable, or wire to be passed along said fine-dimension slit into and from a respective one of said plural apertures.

2. The guide device of claim 1 wherein said flange portion is resiliently yieldable so that said adjacent slit edges are yieldable from a first position of substantial alignment to a second position out of alignment allowing a cord, cable, or wire to pass along said slit; and said slit edges returning to said first position of substantial alignment due to resilience of said flange portion.

3. The guide device of claim 1 wherein said flange portion is plastically yieldable so that said adjacent slit edges are yielded to and remain in a relative position of misalignment allowing a cord, cable, or wire to pass along said slit in an angulated orientation relative to the elongate extension of said guide device; and said cord, cable, or wire when allowed to depend by its own weight substantially vertically in said aperture and substantially perpendicular to the extension of said guide device is retained in said aperture.

4. The guide device of claim 1 wherein said guide device is of L-shape in cross section.

5. The guide device of claim 1 wherein said guide device is of T-shape in cross section.

6. The guide device of claim 1 wherein said guide device is formed of metal, and said flange portion is integral with said base portion.

7. The guide device of claim 1 wherein said guide device is formed of extruded plastic with said flange portion integral with said base portion, and said plastic is selected to have a Durometer sufficiently high to make said guide device shape-retaining, and the selected Durometer of the plastic is also sufficiently low that said slit edges can be manually displaced from substantial alignment by finger pressure allowing a cord, cable, or wire to pass along a respective slit into or from a respective aperture after which said slit edges return by inherent resilience of said plastic material to substantial alignment.

8. A method of organizing, guiding, and retainingly positioning cords, cables, and wires of computer system components disposed upon a desktop, said method including steps of:
securing an elongate guide device along an edge of said desktop;
configuring said guide device to include an elongate base portion adapted for securing to said desktop;
providing on said base portion an elongate flange portion protruding away from the desktop;
defining in said elongate flange portion a plurality of apertures spaced apart along the length of said elongate flange portion, and each of sufficient size to accept a cord, cable, or wire;
providing from each aperture and extending to a distal edge of said flange portion a respective one of plural slits each having adjacent closely spaced apart and aligned slit edges defined by parts of said protruding flange portion; and
providing for adjacent slit edges of said flange portion to be yielded out of alignment so as to allow a cord, cable, or wire to pass along a respective slit into and from a respective one of said plurality of apertures.

9. The method of claim 8 further including the steps of providing for said flange portion to be resiliently yieldable so that said adjacent slit edges are manually yieldable from a first position of substantial alignment to a second position out of alignment, thus allowing a cord, cable, or wire to be passed along said slit; and so that said slit edges return by inherent resilience to said first position of substantial alignment.

10. The method of claim 8 further including steps of providing for said flange portion to be plastically yieldable, and yielding adjacent slit edges to a relative position of misalignment allowing a cord, cable, or wire to be angulated relative to the elongate extension of said guide device so as to pass along a slit into a respective aperture; and so that said cord, cable, or wire when allowed to depend by its own weight substantially vertically in said aperture and substantially perpendicular to the extension of said guide device is retained in said aperture.

11. The method of claim 8 wherein said guide device is configured to be substantially of L-shape in cross section.

12. The method of claim 8 wherein said guide device is configured to be substantially of T-shape in cross section.

13. The method of claim 8 further including the step of forming said guide device of metal, and said flange portion is formed integrally with said base portion.

14. The method of claim 8 further including the steps of forming said guide device of plastic material with said flange portion integral with said base portion, and selecting said plastic material to have a Durometer sufficiently high to make said guide device shape-retaining, and selecting the Durometer of the plastic also to be sufficiently low that adjacent slit edges can be manually displaced from substantial alignment by finger pressure allowing a cord, cable, or wire to pass along a respective slit into or from a respective aperture after which said slit edges return by inherent resilience of said plastic material to substantial alignment.

15. An elongate guide device for cords, cables, and wires, said guide device being particularly adapted for installation along an edge of a desktop for guiding and retaining cords, cables and wires of computer system components disposed upon said desktop, said guide device comprising: an elongate base portion providing a surface disposed toward said desktop, said base portion providing for securing said guide device along an edge of said desktop; said base portion carrying a elongate yieldable flange portion protruding away from the desktop and defining an elongate distal termination edge; said yieldable flange portion defining plural through apertures spaced along its length, and said flange portion further defining plural slits each connecting a respective one of said plural apertures with said elongate distal edge, and each of said plural slits having adjacent closely spaced apart and aligned slit edges defined by parts of said protruding yieldable flange portion; whereby, adjacent slit edges of said yieldable flange portion are yieldable out of alignment with one another and the remainder of said yieldable flange portion so as to allow a cord, cable, or wire to be passed along said slit into and from a respective one of said plural apertures.

16. The guide device of claim 15 wherein said flange portion is resiliently yieldable so that said adjacent slit edges are yieldable from a first position of substantial alignment to a second position out of alignment allowing a cord, cable, or wire to pass along said slit; and said slit edges returning to said first position of substantial alignment due to resilience of said flange portion.

17. The guide device of claim 15 wherein said flange portion is plastically yieldable so that said adjacent slit edges are yielded to and remain in a relative position of misalignment allowing a cord, cable, or wire to pass along said slit in an angulated orientation relative to the elongate extension of said guide device; and said cord, cable, or wire when allowed to depend by its own weight substantially vertically in said aperture and substantially perpendicular to the extension of said guide device is retained in said aperture.

18. The guide device of claim 15 wherein said guide device is of L-shape in cross section.

19. The guide device of claim 15 wherein said guide device is of T-shape in cross section.

20. The guide device of claim 15 wherein said guide device is integrally formed of plastic material with said plastic material being selected to on the one hand provide for said guide device to be shape-retaining, and on the other hand said plastic material being sufficiently yieldable and resilient to allow adjacent slit edges to be manually displaced from substantial alignment by finger pressure allowing a cord, cable, or wire to pass along a respective slit into or from a respective aperture, after which said slit edges return by inherent resilience of said plastic material to substantial alignment.
